(19) United States
(12) Patent Application Publication
(10) Pub. No.: US 2026/0236845 A1
(43) Pub. Date: Aug. 13, 2026

(54) AEROSPACE ENGINE BLADE INSPECTION SYSTEM

(71) Applicants: Khalifa University of Science and Technology, Abu Dhabi (AE); Aerospace Holding Company LLC, Abu Dhabi (AE)

(72) Inventors: Ehtesham Iqbal, Abu Dhabi (AE); Mohammed Ahmed Mohammed Eltoum Mohammed Ali, Abu Dhabi (AE); Abdelrahman Youssef Elmaghawry Sayed Ahmed, Abu Dhabi (AE); Yusra Abdulrahman, Abu Dhabi (AE); Yahya Zweiri, Abu Dhabi (AE); Brain Moyo, Abu Dhabi (AE); Abdallah Mohammad Alkilany, Abu Dhabi (AE); Aiswarya Babu, Abu Dhabi (AE)

(21) Appl. No.: 19/534,500

(22) Filed: Feb. 9, 2026

Related U.S. Application Data
(60) Provisional application No. 63/755,543, filed on Feb. 7, 2025.

(51) Int. Cl. G06N 20/00; G06V 10/764; G06V 10/82

(52) U.S. Cl. CPC G06N 20/00; G06V 10/764; G06V 10/82

(57) ABSTRACT

A system may leverage deep-learning artificial intelligence (AI) to support a robotic system for inspecting aerospace engine blades. The system may receive an input of a computer-aided design (CAD) model and material texture. The system can use the deep learning AI model to generate a three-dimensional (3D) synthetic dataset of the model and to apply noise to the synthetic dataset in order to mimic real world defects. The defects may be labeled by an auto-annotation process and may be entered into a defect dataset to continuously train the deep learning AI model. The model may be able to be used to identify defects of the aerospace engine blades.

### CROSS-REFERENCES TO RELATED APPLICATIONS

This application claims the benefit of Provisional Patent Application No. 63/755,543, filed Feb. 7, 2025, the entire contents of which are hereby incorporated by reference for all purposes in its entirety.

### BACKGROUND OF THE INVENTION

The aero-engine blade (AEB), a rotating component, is subjected to harsh environments and complex loads during operation. This susceptibility can make them prone to fatigue defects due to excessive stress. The aviation industry relies on engine maintenance, repair, and overhaul (MRO) to maintain airworthiness and safe operations. Frequent inspections, such as scheduled or unscheduled, are performed to ensure aircraft safety. Other systems and/or techniques involve manual inspection systems based on human vision and may be merely supplemented by, if present at all, video-based vision systems (borescopes). However, the other systems and/or techniques have numerous limitations. For example, the other systems and/or techniques are time-consuming, error-prone, labor-intensive, and contribute to lengthy maintenance cycles. Similarly, video-based vision systems like borescopes are not accurate. The other systems and/or techniques return inaccurate results.

### BRIEF SUMMARY OF THE INVENTION

To address the above-described challenges, a surface inspection system for aerospace engine blades that leverages artificial intelligence (AI)-based deep-learning models to detect defects can be used. The surface inspection system can autonomously pick up the aeroengine blade, move it to the camera for image capturing, and process the captured image using an AI deep-learning-based model for defect analysis. The surface inspection system also leverages the deep-learning AI model to generate and compare three-dimensional (3D) transformations of synthetic and defect datasets. An autonomous surface inspection system may in some instances be utilized to capture images of one or more surfaces with one or more defects. The deep-learning AI model may generate a physics-based rendered synthetic dataset of aerospace engine blades, which is the first of its kind for this purpose.

In some embodiments, a robotic system can be used to inspect surfaces of aerospace engine blades. The robotic system can include a robotic arm configured to manipulate the aerospace engine blades, and the robotic system can include a computing device. The computing device can generate a set of synthetic data that can be used to train a deep-learning artificial intelligence model. The set of synthetic data can be generated based on a physics-based rendering technique. The computing device can detect, using the trained deep-learning artificial intelligence model, one or more defects on the aerospace engine blades. The trained deep-learning artificial intelligence model can identify the one or more defects based on a three-dimensional (3D) transformation of the one or more defects. The 3D transformation can be based on a set of labeled defects available from the set of synthetic data, and the one or more defects can be present on a subset of the aerospace engine blades. The computing device can manipulate each aerospace engine blade included in the subset of the aerospace engine blades based on surfaces of the subset of the aerospace engine blades having the one or more defects.

### BRIEF DESCRIPTION OF THE DRAWINGS

Various embodiments in accordance with the present disclosure will be described with the present disclosure will be described with reference to the drawings in which:

FIG. 1 is a schematic view of an example robotic system including an imaging system in accordance with at least one embodiment.

FIG. 2 is a data flow diagram of an example of a process to generate a synthetic dataset using a physics-based rendering process in accordance with at least one embodiment.

FIG. 3 is a data flow diagram of an example of a process to generate a defect dataset to train deep-learning models in accordance with at least one embodiment.

FIG. 4 shows examples of 3D transformations in accordance with at least one embodiment.

FIG. 5 is a flow chart of an example of the generation of a synthetic dataset using a physics-based rendering process in accordance with at least one embodiment.

FIG. 6 is a flow chart of an example of a deep-learning Artificial Intelligence identifying at least one defect and generating a defect dataset in accordance with at least one embodiment.

FIG. 7 is a block diagram of an example of a computer system that can be used to control a robotic manipulator with an inspection system in accordance with at least one embodiment.

### DETAILED DESCRIPTION OF THE INVENTION

Certain aspects and features of the present disclosure relate to an autonomous robotic system with a deep-learning artificial intelligence (AI) model can capture and process images of aerospace blades to identify defects of the blades. Some examples of defects may include nicks, corrosion, dents, or scratches apparent on one or more surfaces of an aerospace blade or alternative structure. Aerospace blade defects, when overlooked, may lead to engine failure for intended performance and can result in flight shut down procedures or other negative consequences. Capturing defects before assembly of the aerospace blade in an engine may prevent costly repairs, may prevent failure of the engine, and may decrease production time if the blades do not need to be replaced. The autonomous robotic system can use the AI model to manipulate the blades and to identify defects on the blades such as via a physics-based rendering system. The physics-based rendering system can be used to generate a synthetic, manipulatable model that may be adjusted by the AI model through input of noise to create a defect dataset to continuously learn and identify defects.

A synthetic dataset may be developed by generating an inspection scene from a computer aided design (CAD) model and an input of the material texture of the surface being inspected. A physics-based rendering process, such as domain randomization, can be applied to the inspection scene to create a synthetic dataset. A synthetic dataset can be artificially generated data that may be able to replicate real world data. The use of synthetic data may allow the AI model to artificially manipulate the characteristics of the dataset. An AI model may be trained on a synthetic dataset by introducing changes to the characteristics of the dataset. The AI model may identify and label the product of the manipulated synthetic dataset and may learn, or be trained on, how the new changes correlate to real life changes of the product being synthetically modeled. A synthetic dataset can be generated for training the deep-learning model using the synthetic dataset techniques described herein. The AI-based inspection model can be installed into the robotic automation system, and real-time inspections can be performed. The accuracy and efficiency of the AI system can be enhanced using fine-tuning methods, and the performance of the system can be verified.

A deep-learning AI model may include a subset of a machine-learning model. The deep-learning AI model may be developed with multiple interconnected layers that can each be capable of solving a mathematical operation. The multiple interconnected layers of processing allows for weights to be distributed along different characteristics. This may allow for the deep-learning AI model to generate more accurate results compared with other models.

The autonomous robotic system can use domain randomization, which can include a process in which an AI model may be trained through generating models with varying secondary parameters. Secondary parameters can include parameters to be set and identified as parameters not of significant consequence, or of less consequence than other parameters, to the model. The AI model sufficiently trained in a physics-based rendering process such as domain randomization may generate a model or dataset with greater accuracy of the relevant features without over-relying on generating secondary features. The primary features and the secondary features may be set by a user or determined by the AI model.

A surface inspection system, such as a system associated with the autonomous robotic system, can involve various components and/or techniques. For example, the surface inspection system may capture images that may assist with modifying a generated synthetic dataset for deep-learning model training. The surface inspection system may be coupled with a robotic system, such as the autonomous robotic system, and may capture images of surfaces that may include defects. The surface inspection system may also be separate from the housing of the robotic system and may depend on the robotic arm of the robotic system to transfer the blade to the surface inspection system. The deep-learning AI model may use the captured images as a reference when applying noise to a synthetic dataset to generate a model with perturbations mimicking the defects captured.

The surface inspection system may include a non-contact system. A dedicated camera system of the surface inspection system can capture images of one or more surfaces, and the images can be processed and used as a reference for a software program to identify a defect compared to a reference image or model. The deep-learning AI model may adjust the error detection rates for the defects present on the aerospace blade, and a fine-tuning process may be used to capture a sufficient level of detail for defect analysis.

Additionally, or alternatively, the surface inspection system can involve automating the surface inspection system with an image acquisition system for real-time implementation. The synthetic dataset can be generated, and the deep-learning AI model can be trained and integrated with a robotic system for automation. The image acquisition system can be attached to the robotic system. An image acquisition system, for example a camera system, may be attached to the arm of the robotic system to allow image capture to occur such as while the aerospace blade is being moved. A robotic arm and robotic end effector may be attached to the automated system to autonomously pick up the aerospace blade for image capture and processing. A robotic end effector can include a tool at the end of the robotic arm assembled to interact with environmental objects.

A defect dataset may be generated by the deep-learning AI model applying noise to the synthetic dataset. Input noise may be applied to the three-dimensional (3D) generated dataset. Noise, such as when applied in one instance to a synthetic dataset, may generate 3D transformations with defects apparent on the model. In some examples, an aerospace blade model with noise may generate a transformation as a blade with some form of corrosion present. An output of applying noise to a 3D generated dataset can include a perturbation within the synthetic dataset. The perturbation may be generated as a 3D transformation of the defect. Once labeled, the defect may be stored in the defect dataset.

The deep-learning AI model can identify defects by taking the difference of the generated 3D transformation and comparing it to a reference structure, for example a CAD model, and identifying differences. An automated annotation process may be able to identify and label defects. In some examples a user may input a defect label at a terminal, and an AI model may augment or enhance the defect label. The labeled defect can be stored at the defect dataset.

As the image acquisition system records images of the aerospace blade, one or more images from one or more angles of the aerospace blade may be captured. Once the image or images are captured, the deep-learning AI model may analyze one or more images. The deep leaning AI model may generate a 3D transformation with noise to most closely mimic the defect analyzed from the captured image. The defect dataset can be used to most closely label the mimicked defect to a defect present in the dataset, and an output may be generated with the apparent one or more defects on the physical aerospace blade surface identified.

In some examples, the inspection system described herein can leverage a robotic system with an image acquisition system for automating each step of the inspection process or any subset thereof. The inspection system can reduce human error and can shorten maintenance processes, thereby preventing increases in engine failure rates and ensuring a higher realization of aircraft safety. The inspection system may generate a synthetic dataset of the aerospace engine blades that can be created using physics-based rendering methods, for example the usage of domain randomization may be one such method. This approach addresses the data limitations in the aerospace industry for training AI models by providing high-quality, diverse training data.

The inspection system may allow for the continued development of an AI detection model. The AI detection model may depend upon a substantial amount of labeled data. The design and training of an AI detector model on the synthetic dataset can be performed, ensuring its effectiveness and robustness when applied to real-time datasets. Additionally, or alternatively, the AI detector model can be integrated into an automated system involving a robotic arm. The system can automate the inspection process, including picking up the blade, image acquisition, preprocessing, model inference, feedback based on the results, and accurately placing the blade back in its designated location.

The surface inspection system described herein may extend beyond the aerospace industry. Since the techniques that can be performed by the surface inspection system may not be domain-specific, the techniques, and by extension the surface inspection system, can be applied across various manufacturing industries or other suitable industries that have limited data for deep-learning model applications and in which inspection processes are performed for operational continuity.

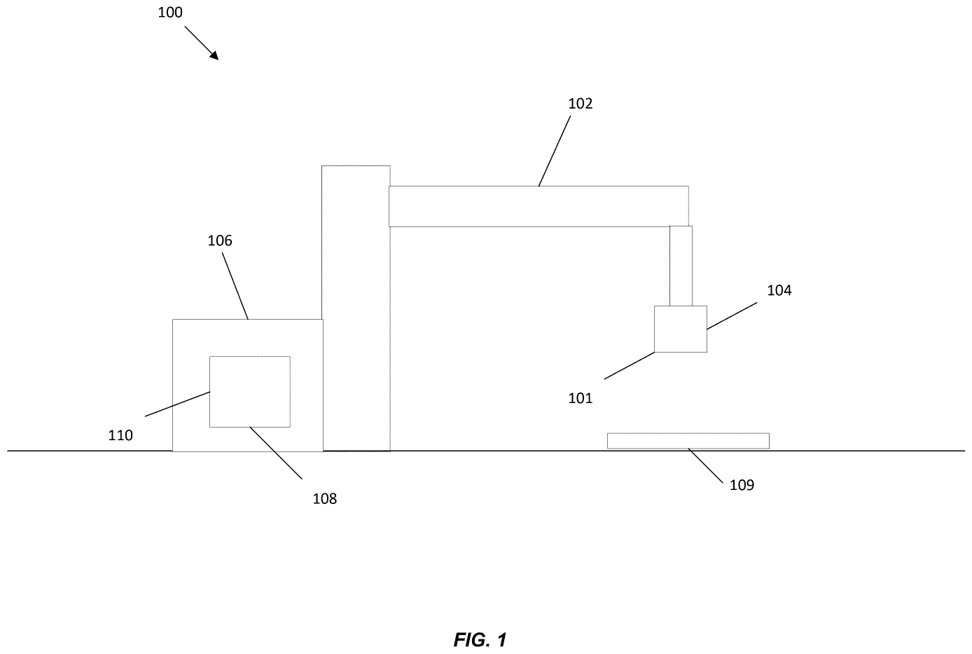

FIG. 1 is a schematic view of an example of a robotic system 100 including an imaging system 101 in accordance with at least one embodiment. Autonomous generation of a synthetic dataset may be performed by a robotic system 100 and can be used to perform a surface inspection process. As illustrated in FIG. 1, the robotic system 100 can include a robotic arm 102, an end effector 104, and a software system 106 that can be used to facilitate the surface inspection process as described herein. The software system 106 can include or can otherwise use a deep-learning artificial intelligence model 108 to detect details about one or more surfaces 109. The software system 106 may be displayed on a terminal at which a user may be capable of entering one or more inputs and viewing outputs of the deep-learning AI model. The deep-learning artificial intelligence model 108 can be trained using synthetic data generated using a synthetic data generation service 110. The software system 106 can be used to control the robotic arm 102 and/or the end effector 104 to perform the inspection process on one or more surfaces 109 of one or more components, which can include one component, such as an engine blade or other suitable components, or more than one component. The imaging system 101 may be attached to the robotic system 100. The deep-learning artificial intelligence model 108 may access the images so that the deep-learning artificial intelligence model 108 may be able to reference the images of the one or more surfaces 109.

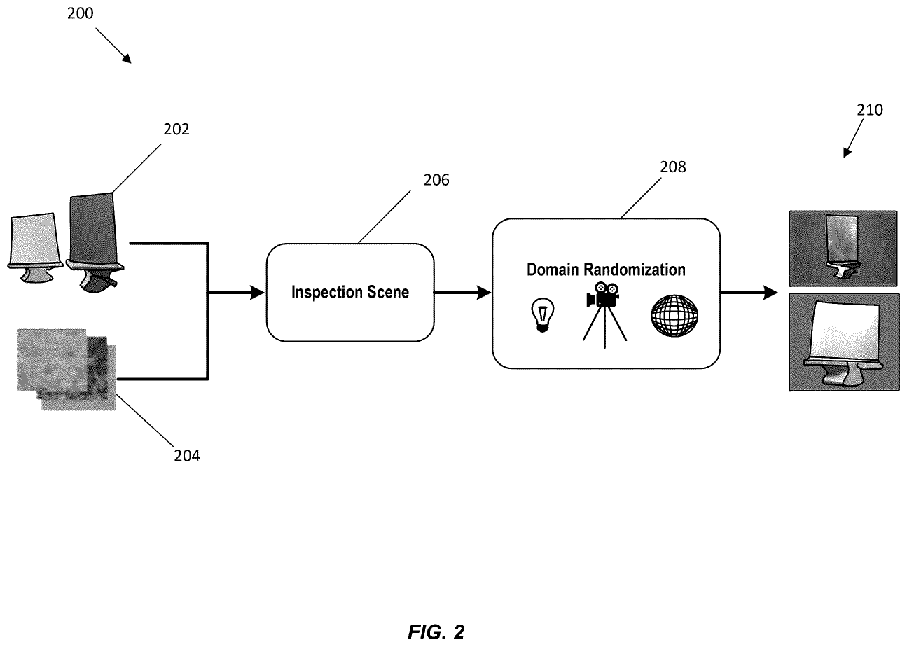

FIG. 2 is a data flow diagram of an example of a process 200 to generate a synthetic dataset using a physics-based rendering process in accordance with at least one embodiment. In some examples, FIG. 2 illustrates an overview of synthetic image generation. As illustrated in FIG. 2, the process 200 may begin with a CAD model 202 and a material texture 204. A CAD model 202 and material texture 204 may be selected by the AI model or detected using a robotic system such as the robotic system 100 illustrated and described with respect to FIG. 1. An input can be generated that includes the CAD model 202 and the material texture 204, and the input may be received at a terminal coupled with the software system 106 of the robotic system 100. A material texture 204 may also be identified through the deep-learning artificial intelligence model 108, which can process and use an auto-annotation technique on captured images from the imaging system 101.

An inspection scene 206 can be generated with the CAD model 202 and material texture 204. An inspection scene may be a 3D generation of a specific area or object and may be modified to render measurements and visualizations of an object. A physics-based modeling technique 208 may be applied to the inspection scene 206 to generate a synthetic dataset 210. In some embodiments, the physics-based modeling technique 208 can include domain randomization. For example, the physics-based modeling technique 208 can involve adjusting non-essential aspects of generation such as a factor for lighting or graphical quality. Applying the physics-based modeling technique 208 to the inspection scene 206 can generate a synthetic dataset 210. The generated synthetic dataset 210 can include a dataset that may be modeled as a 3D generation and can be manipulated to allow for changes in data to reflect real world conditions. A 3D model may be referenced to as a 3D generation. The generated model included in the output of the synthetic dataset 210 can include a 3D model of the aerospace blade.

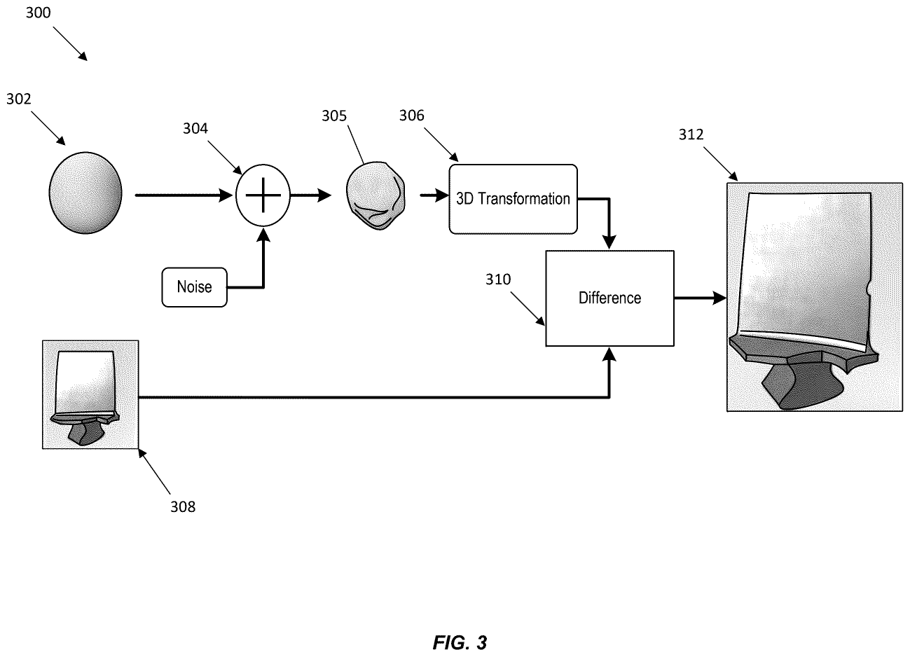

FIG. 3 is a data flow diagram of an example of a process 300 to generate a defect dataset to train deep-learning models in accordance with at least one embodiment. As illustrated in FIG. 3, the process 300 may begin with generated synthetic dataset 302. The generated synthetic dataset 302 can include or otherwise relate to the 3D generation of the synthetic dataset 210. The generated synthetic dataset 302 can include a manipulatable set of data that may be modified to teach or train the deep-learning artificial intelligence model 108. Once the generated synthetic dataset 302 is modified, an auto-annotation process may be applied to label identified defects.

A defect dataset 312 may be generated by applying noise 304, to the generated synthetic dataset 302. The generated synthetic dataset 302 can be modified by the noise 304 until the generated synthetic dataset 302 mimics a perturbation 305 resembling a defect of an aerospace blade. The noise 304 may be an input from the deep-learning artificial intelligence model 108 in which multiple iterations of varying levels and types of noise 304 can be applied so a defect may be mimicked closest to real world conditions. The perturbation 305 can include a change in the synthetic dataset 210 and may be applied to mimic real world defects such as nicks, corrosions, dents, scratches, or a combination thereof and/or other defects that may occur. A 3D transformation 306 can be generated from the perturbation 305. The deep-learning artificial intelligence model 108 may receive a difference 310 between a reference model 308 and the 3D transformation 306 to identify one or more defects. An auto-annotation process may label the defect, and the labeled defect can be added to the defect dataset 312.

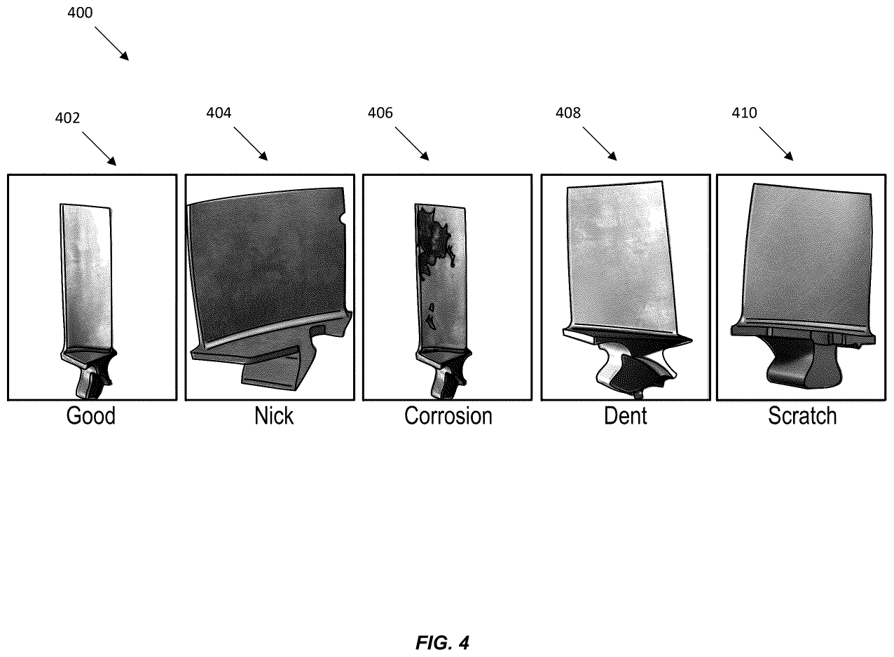

FIG. 4 shows examples of 3D transformations 400 in accordance with at least one embodiment. A 3D transformation can include a 3D generation of a synthetic dataset 302 and may be generated with noise 304 and by using the process 300 as illustrated and described with respect to FIG. 3. A 3D generated dataset with no defects may be labeled as a good 3D generation. A 3D generation with a nick defect 404 is a generated synthetic dataset 302, with noise 304, mimicking a slight discontinuity of the aerospace blade such as along a perimeter of the blade. The discontinuity may be generated as an indentation or a removed portion of the material of the aerospace blade. A 3D generation with a corrosion defect 406 is a generated synthetic dataset 302 in which noise 304 is introduced to mimic, for example, degradation of the aerospace blade by environmental interactions. A 3D generation with a dent defect 408 can involve the synthetic dataset 302 perturbed by noise 304 to mimic a localized depression in which the material of the aerospace blade may be deformed but not removed. A 3D generation with a scratch defect 410 can be included in a generated synthetic dataset 302, and perturbed with noise 304, to mimic a discontinuity of the surface of the aerospace blade with minimal or no material removal and no significant deformation. Other possible defects are possible than those illustrated in FIG. 4.

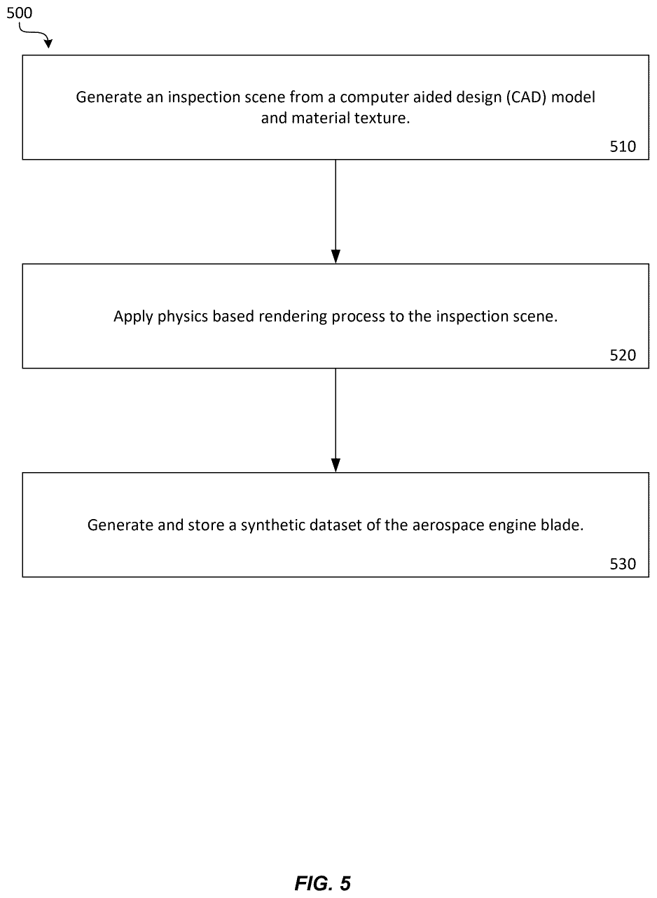

FIG. 5 is a flow chart of an example of a process 500 for generating a synthetic dataset using a physics-based rendering process. At block 510, an inspection scene is generated from a CAD model and an identified material texture. The material texture may be identified by the deep-learning artificial intelligence model 108 processing images from the image acquisition system such as the imaging system 101 of the robotic system 100. The inspection scene may include a 3D generation of an aerospace blade that may be capable of being modified.

At block 520, a physics-based modeling technique 208 is applied to the inspection scene generated at the block 510. In some examples, domain randomization may be used as the physics-based modeling technique 208. Domain randomization may be achieved by the deep-learning artificial intelligence model 108 adjusting secondary features of the render until a 3D generation is modeled similar to the model aerospace blade.

At block 530, an output from applying a physics-based rendering process to the inspection scene is generated as a synthetic dataset 210. The synthetic dataset 210 can be stored on a memory device. The output of applying a physics-based modeling technique 208 is a 3D generation closely resembling the CAD model 202 in a 3D environment. The synthetic dataset 210 can be used in subsequent processes, such as process 600, to support operations of the robotic system 100 and the deep-learning AI model 108.

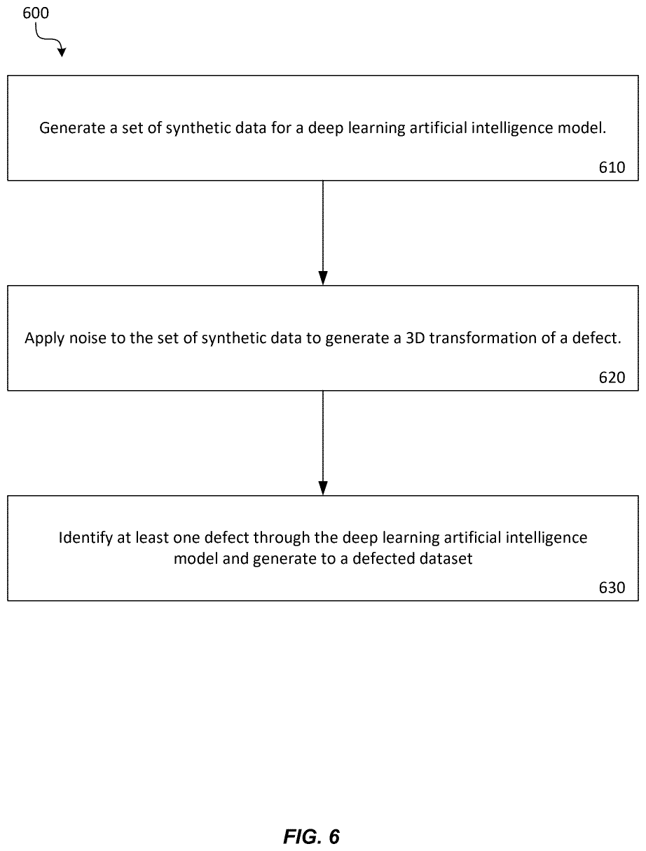

FIG. 6 is a flow chart of a process 600 to identify at least one defect and generate a defect dataset using a deep-learning AI model. At block 610, a synthetic dataset is generated. The synthetic dataset 302 can be generated such as based on the process 200 or the process 300. A model, such as a CAD model 202 or a material texture 204, can be combined to create an inspection scene 206, and a physics-based modeling technique 208 may be applied to create and render the generated synthetic dataset 302.

At block 620, noise 304 is applied to the synthetic dataset 302. The noise 304 applied to the synthetic dataset 302 can modify the synthetic dataset 302 and can create a 3D transformation 306 in which a defect may be apparent or identified. The 3D transformation 306 can be compared to a reference model 308, for example the CAD model of an aerospace blade, such that the deep-learning artificial intelligence model may identify differences between the 3D transformation 306, and the reference model 308.

At block 630 an auto-annotation process may be utilized to identify and label at least one defect. For example, the deep-learning AI model 108 may identify a defect and may reference the defect dataset 312 to select the defect that is most similar. The labeled defect may then be added to the defect dataset for use in training machine-learning models and/or for use in identifying defects in aerospace engine blades inspected by the robotic system 100.

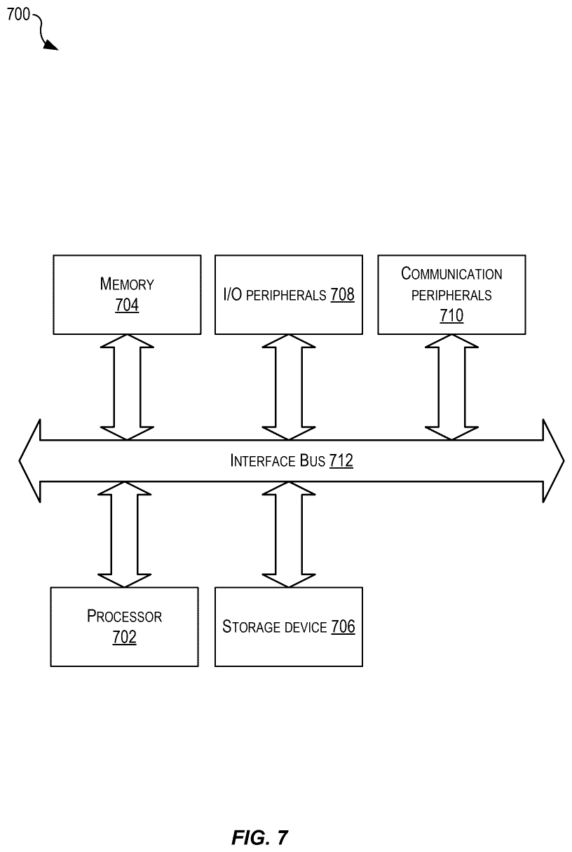

FIG. 7 illustrates examples of components of a computer system 700, according to at least one example. In some examples, the computer system 700 can be used by the robotic system 100 such as via the software system 106. The computer system 700 may be a single computer such as a user computing device and/or can represent a distributed computing system such as one or more server computing devices. In some examples, the computer system 700 may be configured to control the operation of one or more automated elements, such as robotic arm 102 of the robotic system 100 of the robotic system manipulators, and the end effector 104 of the robotic system 100, and any other automated equipment, of a warehouse, manufacturing facility, bottling facility, packing facility, or the like.

The computer system 700 may include at least a processor 702, a memory 704, a storage device 706, input/output peripherals 708, communication peripherals 710, and an interface bus 712. The interface bus 712 is configured to communicate, transmit, and transfer data, controls, and commands among the various components of the computer system 700. The memory 704 and the storage device 706 include computer-readable storage media, such as Radom Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any such computer-readable storage media can be configured to store instructions or program codes embodying aspects of the disclosure. The memory 704 and the storage device 706 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 700.

Further, the memory 704 includes an operating system, programs, applications, and/or other software, models, modules, and the like. The processor 702 is configured to execute the stored instructions and includes, for example, a logical processing unit, a microprocessor, a digital signal processor, and other processors. The memory 704 and/or the processor 702 can be virtualized and can be hosted within another computing system of, for example, a cloud network or a data center. The input/output peripherals 708 include user interfaces, such as a keyboard, screen (e.g., a touch screen), microphone, speaker, other input/output devices, and computing components, such as graphical processing units, serial ports, parallel ports, universal serial buses, and other input/output peripherals. The input/output peripherals 708 are connected to the processor 702 through any of the ports coupled to the interface bus 712. The communication peripherals 710 are configured to facilitate communication between the computer system 700 and other computing devices over a communications network and include, for example, a network interface controller, modem, wireless and wired interface cards, antenna, and other communication peripherals.

What is claimed is:

1. A robotic system for inspecting surfaces of a plurality of aerospace engine blades, the robotic system comprising:
a robotic arm configured to manipulate the plurality of aerospace engine blades; and
a computing device configured to perform operations comprising:
generating a set of synthetic data usable to train a deep-learning artificial intelligence model, the set of synthetic data generated based on a physics-based rendering technique;
detecting, using the trained deep-learning artificial intelligence model, one or more defects on the plurality of aerospace engine blades, wherein the trained deep-learning artificial intelligence model identifies the one or more defects based on a three-dimensional (3D) transformation of the one or more defects, wherein the 3D transformation is based on a set of labeled defects available from the set of synthetic data, and wherein the one or more defects are present on a subset of the plurality of aerospace engine blades; and
manipulating each aerospace engine blade included in the subset of the plurality of aerospace engine blades based on surfaces of the subset of the plurality of aerospace engine blades having the one or more defects.

2. The robotic system of claim 1, wherein the computing device further comprises an image acquisition system configured to capture and store a set of recorded images of the surfaces to facilitate detecting the one or more defects.

3. The robotic system of claim 1, wherein the computing device is further configured to perform additional operations comprising:
recording a modeled dataset comprising a computer aided design (CAD) model of an aerospace engine blade of the plurality of aerospace engine blades; and
receiving a material texture to be used in combination with the CAD model of the aerospace engine blade.

4. The robotic system of claim 3, wherein the computing device is further configured to perform additional operations comprising:
generating a synthetic dataset comprising data recorded from the modeled dataset and material texture; and
applying the physics-based rendering technique comprising domain randomization.

5. The robotic system of claim 1, wherein the computing device is further configured to perform additional operations comprising generating the 3D transformation by applying noise to a synthetic dataset that creates a perturbation, wherein the 3D transformation is generated with one or more separate defects mimicking the one or more defects included in a set of recorded images, and wherein the one or more defects are labeled by training the trained deep-learning artificial intelligence model to identify one or more defects from the set of labeled defects, and wherein the one or more defects are generated without a label.

6. The robotic system of claim 1, wherein the computing device is further configured to perform additional operations comprising:
training the trained deep-learning artificial intelligence model to compare a difference of the 3D transformation and a modeled dataset; and
generating a defect dataset with the one or more defects present on the subset of the plurality of aerospace engine blades.

7. The robotic system of claim 1, wherein the computing device is further configured to perform additional operations comprising:
recording a user input for defects at a terminal of the computing device; and
storing the user input into the set of labeled defects, wherein the trained deep-learning artificial intelligence model is further trained utilizing the user input for defects and a defect dataset.

8. The robotic system of claim 1, further comprising a detection system coupled with a robotic arm configured to automate a detection process for detecting the one or more defects by picking up the plurality of aerospace engine blades and moving the plurality of aerospace engine blades to a desired location.

9. A method comprising:
generating a set of synthetic data usable to train an artificial intelligence model, the set of synthetic data generated based on a physics-based rendering technique;
detecting, using the trained artificial intelligence model, one or more defects on one or more objects, wherein the trained artificial intelligence model identifies the one or more defects based on a three-dimensional (3D) transformation of the one or more defects, wherein the 3D transformation is based on a set of labeled defects available from the set of synthetic data, and wherein the one or more defects are present on a subset of the one or more objects; and
manipulating each object included in the subset of the one or more objects based on surfaces of the subset of the one or more objects having the one or more defects.

10. The method of claim 9, further comprising capturing and storing images using an image acquisition system to facilitate detecting the one or more defects.

11. The method of claim 9, further comprising:
recording a modeled dataset comprising a computer aided design (CAD) model of an aerospace blade; and
receiving a material texture to be used in combination with the CAD model of the aerospace blade.

12. The method of claim 11, further comprising:
generating a synthetic dataset comprising data recorded from the modeled dataset and material texture; and
applying a physics based rendering technique, comprising domain randomization.

13. The method of claim 9, further comprising generating the 3D transformation through applying noise to a synthetic dataset, creating a perturbation wherein the 3D transformation is generated with one or more defects mimicking the one or more defects of a set of recorded images, wherein the one or more defects are labeled by configuring the trained artificial intelligence model, which is a trained deep-learning artificial intelligence model, to identify one or more defects from the set of labeled defects or through a user input for defects, wherein the one or more defects are generated without a label.

14. The method of claim 13, further comprising:
configuring the trained deep-learning artificial intelligence model to compare a difference of the 3D transformation and a modeled dataset; and
generating a defect dataset with the one or more defects present on a subset of the one or more objects.

15. A non-transitory computer-readable medium comprising instructions that are executable by a processing device for causing the processing device to perform operations comprising:
generating a set of synthetic data usable to train an artificial intelligence model, the set of synthetic data generated based on a physics-based rendering technique;
detecting, using the trained artificial intelligence model, one or more defects on one or more objects, wherein the trained artificial intelligence model identifies the one or more defects based on a three-dimensional (3D) transformation of the one or more defects, wherein the 3D transformation is based on a set of labeled defects available from the set of synthetic data, and wherein the one or more defects are present on a subset of the one or more objects; and
manipulating each object included in the subset of the one or more objects based on surfaces of the subset of the one or more objects having the one or more defects.

16. The non-transitory computer-readable medium of claim 15, further comprising instructions that are executable by the processing device for causing the processing device to perform further operations comprising capturing and storing images using an image acquisition system to facilitate detecting the one or more defects.

17. The non-transitory computer-readable medium of claim 15, further comprising instructions that are executable by the processing device for causing the processing device to perform further operations comprising:
recording a modeled dataset comprising a computer aided design (CAD) model of an aerospace blade; and
receiving a material texture to be used in combination with the CAD model of the aerospace blade.

18. The non-transitory computer-readable medium of claim 17, further comprising instructions that are executable by the processing device for causing the processing device to perform further operations comprising:
generating a synthetic dataset comprising data recorded from the modeled dataset and material texture; and
applying a physics based rendering technique, comprising domain randomization.

19. The non-transitory computer-readable medium of claim 15, further comprising instructions that are executable by the processing device for causing the processing device to perform further operations comprising generating the 3D transformation through applying noise to a synthetic dataset, creating a perturbation wherein the 3D transformation is generated with one or more defects mimicking the one or more defects of a set of recorded images, wherein the one or more defects are labeled by configuring the trained artificial intelligence model to identify one or more defects from the set of labeled defects or through a user input for defects, wherein the one or more defects are generated without a label.

20. The non-transitory computer-readable medium of claim 15, further comprising instructions that are executable by the processing device for causing the processing device to perform further operations comprising:
recording a user input for defects at a terminal associated with the non-transitory computer-readable medium;
storing the user input into the set of labeled defects; and
continuously training the trained artificial intelligence model utilizing the user input for defects and a defect dataset.
